(19) United States
(12) Patent Application Publication
(10) Pub. No.: US 2010/0064234 A1
(43) Pub. Date: Mar. 11, 2010

(54) System and Method for Browser within a Web Site and Proxy Server

(75) Inventors: Zvi Schreiber, Jerusalem (IL); Yousef Abdalkaream Mustafa Ghandour, Kufur Aqab (IL); Hamza Khalil Hasan Alhalayqa, Hebron (XP); Mohammad Shaheen Mohammad Shaheen, Ramallah (XP)

Correspondence Address: SIMON KAHN - PYI Tech, Ltd.;c/o LANDONIP, INC, 1725 Jamieson Avenue, ALEXANDRIA, VA, 22314, US

(73) Assignee: GHOST, INC., Tortola (VG)

(21) Appl. No.: 12/530,461

(22) PCT Filed: Mar. 9, 2008
(86) PCT No.: PCT/IL08/00317

§ 371 Date: Sep. 9, 2009

Related U.S. Application Data
(60) Provisional application No. 60/893,968, filed on Mar. 9, 2007.

(51) Int. Cl. G06F 3/00

(52) U.S. Cl. 715/760

(57) ABSTRACT

A computer implemented method of browsing, comprising: rendering a browser within a web page; inputting a target URL in an input field of said web page browser; submitting said input target URL to a proxy server as a request; proxifying said request; forwarding said proxified request to said target URL; receiving a response to said proxified request; and forwarding said received response to said rendered web page browser, wherein said web page browser renders the forwarded response without being overwritten.

### CROSS-REFERENCE TO RELATED APPLICATIONS

This application claims priority from U.S. Provisional Patent Application Ser. No. 60,893,968 filed Mar. 9, 2007, entitled “Virtual Hosted Operating System” the entire contents of which is incorporated herein by reference.

This application is further related to the following co-pending, co-filed and co-assigned patent applications, the entire contents of each of which are incorporated herein in their entirety by reference: “A VIRTUAL IDENTITY SYSTEM AND METHOD FOR WEB SERVICE”, docket GHO-005-PCT; “A VIRTUAL FILE SYSTEM FOR THE WEB” docket GHO-006-PCT; “A GENERAL OBJECT GRAPH FOR WEB USERS”, docket GHO-007-PCT; and “SYSTEM AND METHOD FOR A VIRTUAL HOSTED OPERATING SYSTEM” docket GHO-009-PCT

### BACKGROUND OF THE INVENTION

The present invention is directed to the field of computer software for Web sites, and more particularly to a computer implemented method of implementing a browser within a web page.

It is sometimes desirable inside a first web site to embed content from a second website. Modern browsers therefore provide an HTML element called an iframe, and/or similar elements, which may be embedded in a first web site and which may be supplied with a URL by way of an attribute called ISRC which will direct the browser to load a second web site from the URL into the iframe. Although the first web site may control the ISRC parameter of the iframe, the browser will usually prohibit any communication between code from the first web site and code from the second web site if they are downloaded from different domains.

A simple web browser may be implemented within the first web page by providing (A) an input-text field where a user can type a URL and (B) an iframe, and setting the ISRC of the iframe to equal the URL entered into the input-text field, so that the underlying browser will render a second web page in the iframe. This is the simplest known design for a browser-within-a-web-page.

This idea of a web browser within a web page is particularly relevant to web sites which aim to provide a virtual computer, also known as web desktop. The idea is further relevant as part of the broader concept of a web operating system or virtual hosted operating system which aims to reproduce the experience of a computer running an operating system such as Windows from Microsoft Corporation inside a web page, preferably including the experience of a web browser within that web page.

In particular such a virtual computer may provide user session persistence so that if the user opens a browser-within-a-web-page to a certain address and then returns to the first web site at a later time from a different computer the same browser-within-a-web-page may be recreated and pointed to the same address.

However, a number of limitations are apparent in the above simple design for a browser-within-a-web-page including:
1. The second web page may include hyperlinks with the attribute target=“_top” (or equivalent). When the user clicks on such a hyperlink the underlying browser will load a new page replacing the entire first web page instead of loading it within the iframe as would be desired to preserve the browser-within-a-web-page effect
2. The second web page may include hyperlinks with the attribute target=“_blank” (or equivalent). When the user clicks on such a hyperlink the underlying browser will pop-up a new browser window to render the second web site which again compromises the browser-within-a-web-page effect—a more desirable result might be to pop-open a new iframe still within the first web site
3. The browser-within-a-web-page cannot reliably respond to user requests to store a URL, as a bookmark or favorite, since if the user presses hyperlinks within the iframe the first web page is not notified and will not have an up-to-date record of which URL is being shown inside the iframe at the time of the user request. Similarly the browser-within-a-web-page cannot store a full browsing history and cannot provide a “loading” indicator as it does not know when the second web site completes its loading
4. It is common for websites to deliver cookies which are small pieces of data which are stored by the browser and returned to the server with subsequent requests. This is used to recognize the user. For example if a user identifies herself to a second web site loaded in the browser-within-a-web-page, as User1, the web site will store a cookie on the browser with the content “User1” (or some other unique identifier) and will subsequently greet this user with “Hello User1”. However, if the user subsequently accesses the first web site from a different computer, the cookie will not be present, and even though the browser-within-a-web-page will be reproduced and pointed at the same second web site, the greeting “Hello User1” will not appear thereby compromising the true persistence of the virtual hosted operating system, or other first web site.
5. It is common for a browser to limit a web page to having no more than two simultaneous HTTP connections to a specific domain. Some websites may overcome this by having the website load different resources (such as HTML pages, images, video, script) from different domains or at least from different subdomains, by way of example loading two images from http://images1.thirdpartywebsite.com and two images from http://images2.thirdpartywebsite.com. However proxy servers will typically require those domains to all be accessed via one domain such as a-proxy-server.com and the browser will therefore limit the four images to load two at a time thereby disabling the intended performance optimization and giving the user a slow performance experience.

A proxy server can run on a first server and forward HTTP requests sent from a browser to that first server to a second server, and likewise forward the responses. Known uses for proxy servers are overcoming firewalls and censorships, such as when the direct connection from the browser to the second server is blocked, and for routing traffic through a central server where caching or security precautions are applied. Proxy servers are included in many popular web server products including the Apache Web Server from the Apache Foundation and the Laszlo Presentation Server form Laszlo Inc. of San Mateo, Calif. Hosted “proxification” services are also offered, for example at Proxify.com.

Some proxy servers rely on the browser to send all requests to the proxy server. Others known as anonymous proxy servers such as CGIProxy from James Marshall of Berkley, Calif., (http://www.jmarshall.com/tools/cgiproxy/) mainly rely on the browser to send only the first request to the proxy server. These proxy servers actually modify the content of all responses sent back to the browser so as to have all hyperlinks pointing to the anonymous proxy server. This way the user can click on hyperlinks and continue browsing through the anonymous proxy server without having to repeatedly direct the browser at the anonymous proxy server.

For example suppose the user opens a browser and navigates to http://proxy-server.com?url=secondWebSite.com (which is a request to a proxy server to provide the page from second server secondWebSite.com) and suppose the page associated with secondWebSite.com contains a link to thirdWebSite.com. The anonymous proxy server will modify the link in the page before sending the page back to the browser, to instead point at http://proxy-server.com?url=thirdWebSite.com.

Thus what is needed, and not provided by the prior art, is a means for providing a browser within a web site which overcomes at least some of the limitations mentioned above. Preferably, such a means would enable a browser-within-a-web-site as part of a virtual hosted operating system.

### SUMMARY OF THE INVENTION

In accordance with certain embodiments of the invention a browser-within-a-web-page is implemented in a first web page using an iframe to render the second web page addressed to a target URL. However the iframe second web page does not load from the target URL directly, but instead loads the target URL from an anonymous proxy server situated within the same domain from which the first web page was loaded.

This solves some of the problems associated with a browser-within-a-web-page of the prior art, since as far as the browser-within-a-web-page is concerned, the second web site was loaded from the same domain as the first web site and they may communicate with each other. Thus, the browser-within-a-web-site has an up-to-date record of the URL in the iframe second web page, and can indicate the loading status, since communication is enabled.

In certain embodiment the invention provides for a computer implemented method of browsing, comprising: rendering a browser within a web page; indicating a target URL to the web page browser; submitting the input target URL to a proxy server as a request; forwarding the proxified request to the target URL; receiving a response to the proxified request; and forwarding the received response to the rendered web page browser, wherein the web page browser renders the forwarded response without being overwritten.

In one further embodiment the computer implemented method further comprises proxifying the receive response, wherein the response forwarded to the rendered web page browser is the proxified received response. In one yet further embodiment the proxifying the received response comprises manipulating hyperlinks in the received response.

In one yet further embodiment the manipulated hyperlinks point alternately at more than one subdomain. In another yet further embodiment the proxifying the received response comprises replacing hyperlinks operative to overwrite the web page browser with hyperlinks to the web page browser.

In one yet further embodiment the proxifying the received response comprises modifying network calls in executable code in the received response. In another yet further embodiment the method further comprises: stripping any cookie attached to the received response; storing the stripped cookie; and attaching the stored cookie to a subsequent request to a URL associated with the stored cookie. In another yet further embodiment the method further comprises encapsulating any cookie attached to the received response; and forwarding the encapsulated cookie to the web page browser.

In one further embodiment the method further comprises stripping any cookie attached to the received response; and appending the cookie to the received response as an object, wherein the forwarded received response comprises the appended cookie object. Preferably, the object is a Javascript object.

In one further embodiment the method further comprises prior to the forwarding the proxified request: performing a single sign on to the target URL utilizing stored identity information. In one ever further embodiment the performing the single sign-on comprises sending an HTTP POST with the stored identity information.

In one further embodiment the method further comprises prior to the forwarding the proxified request: modifying the request with a digest responsive to stored identity information, thereby performing single sign on. In another further embodiment the method further comprises adding affiliate codes to the request. In yet another further embodiment the web page browser shows a loading indicator while the received response is rendering.

In certain embodiments the invention independently provides for a machine-readable medium containing instructions for controlling a device to perform a machine implemented method of browsing, the method comprising: rendering a browser within a web page; inputting a target URL in an input field of the web page browser; submitting the input target URL to a proxy server as a request; proxifying the request; forwarding the proxified request to the target URL; receiving a response to the proxified request; and forwarding the received response to the rendered web page browser, wherein the web page browser renders the forwarded response without being overwritten.

In one further embodiment the computer implemented method further comprises proxifying the receive response, wherein the response forwarded to the rendered web page browser is the proxified received response. In one yet further embodiment the proxifying the received response comprises manipulating hyperlinks in the received response.

In one yet further embodiment the manipulated hyperlinks point alternately at more than one subdomain. In another yet further embodiment the proxifying the received response comprises replacing hyperlinks operative to overwrite the web page browser with hyperlinks to the web page browser.

In one yet further embodiment the proxifying the received response comprises modifying network calls in executable code in the received response. In another yet further embodiment the method further comprises: stripping any cookie attached to the received response; storing the stripped cookie; and attaching the stored cookie to a subsequent request to a URL associated with the stored cookie. In another yet further embodiment the method further comprises encapsulating any cookie attached to the received response; and forwarding the encapsulated cookie to the web page browser.

In one further embodiment the method further comprises stripping any cookie attached to the received response; and appending the cookie to the received response as an object, wherein the forwarded received response comprises the appended cookie object. Preferably, the object is a Javascript object.

In one further embodiment the method further comprises prior to the forwarding the proxified request: performing a single sign on to the target URL utilizing stored identity information. In one ever further embodiment the performing the single sign-on comprises sending an HTTP POST with the stored identity information.

In one further embodiment the method further comprises prior to the forwarding the proxified request: modifying the request with a digest responsive to stored identity information, thereby performing single sign on. In another further embodiment the method further comprises adding affiliate codes to the request. In yet another further embodiment the web page browser shows a loading indicator while the received response is rendering.

In certain embodiments the invention independently provides for a proxy server operative to enable virtual hosting, the proxy server comprising: a downloadable client exhibiting a web page within a browser; a proxifying functionality operative to: proxify requests received from the web page browser; forward the proxified request to the target URL; receive a response to the proxified request; and forward the received response to the web page browser, wherein the web page browser renders the forwarded response without being overwritten.

In one further embodiment the proxifying functionality is further operative to: proxify the receive response, wherein the response forwarded to the rendered web page browser is the proxified received response. In another further embodiment proxifying the received response comprises manipulating hyperlinks in the received response. In one yet further embodiment the manipulated hyperlinks point alternately at more than one subdomain of the domain of the proxy server.

In one further embodiment proxifying the received response comprises replacing hyperlinks operative to overwrite the web page browser with hyperlinks to the web page browser. In another further embodiment the proxifying the received response comprises modifying network calls in executable code in the received response.

In one further embodiment the proxy server further comprises a cookie functionality and a cookie store, the cookie functionality operative to: strip any cookie attached to the received response; store the stripped cookie in the cookie store; and attach the stored cookie from the cookie store to a subsequent request to a URL associated with the stored cookie. In one yet further embodiment the cookie functionality is further operative to: encapsulate any cookie attached to the received response; and forward the encapsulated cookie to the web page browser.

In one further embodiment the proxy server further comprises a cookie functionality operative to: strip any cookie attached to the received response; and append the cookie to the received response as an object, wherein the forwarded received response comprises the appended cookie object. Preferably the object is a Javascript object.

In one further embodiment the proxy server further comprises a single sign on functionality operative, prior to the forwarding the proxified request, to: perform a single sign on to the target URL utilizing stored identity information. In one yet further embodiment, performing the single sign-on comprises sending an HTTP POST with the stored identity information.

In one further embodiment the proxy server further comprises a single sign on functionality operative, prior to the forwarding the proxified request, to: modify the request with a digest responsive to stored identity information, thereby performing single sign on. In another further embodiment the proxy server further comprising a URL functionality operative to adding affiliate codes to the request.

Additional features and advantages of the invention will become apparent from the following drawings and description.

### BRIEF DESCRIPTION OF THE DRAWINGS

For a better understanding of the invention and to show how the same may be carried into effect, reference will now be made, purely by way of example, to the accompanying drawings in which like numerals designate corresponding elements or sections throughout.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 illustrates a message flow and architecture for proxying for a browser-within-a-web-page in accordance with certain embodiments of the invention;

FIG. 2 illustrates a design for proxy server cookie functionality processing of response in accordance with certain embodiments of the invention;

FIG. 3 illustrates a high level flow chart for proxy server cookie handling in accordance with certain embodiments of the invention;

FIG. 4 illustrates a design for a proxy server cookie functionality processing of an outbound request in accordance with certain embodiments of the invention;

FIG. 5 illustrates a browser-within-a-web-page, the web site being a hosted virtual computer service; and

FIG. 6 illustrates a high level flow chart of an embodiment of a method in accordance with a principle of the invention.

### DETAILED DESCRIPTION OF THE PREFERRED EMBODIMENTS

The present embodiments enable a computer implemented method of implementing a web proxy server and its application to implementing a browser-within-a-web-page.

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

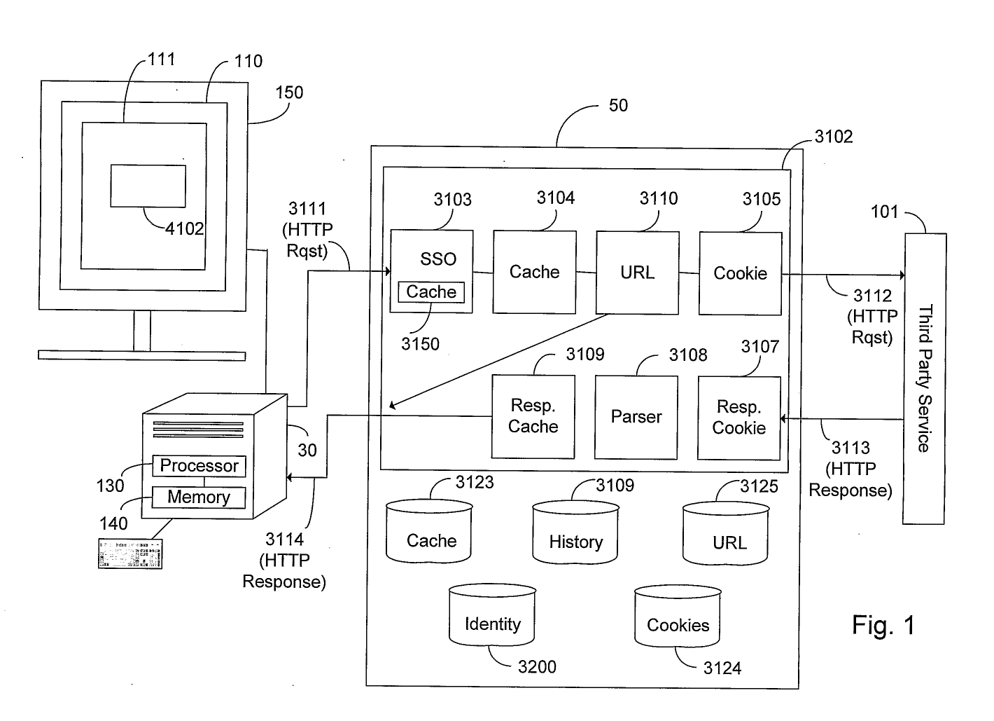

FIG. 1 illustrates a high level architecture 10 for proxying for a browser-within-a-web-page in accordance with certain embodiments of the invention. In particular architecture 10 comprises a data center 50, which is a collection of computing resources not necessarily in one physical data center. Data center 50 comprises a Proxy server 3102 operative to relay data from the Internet, and in particular between a user computer 120 and a third party service 1010.

Computer 120 comprises a processor 130 and a memory 140 associated therewith, and a monitor 150 in communication with processor 130. Computer 120 runs a software code, and in particular a browser 110, normatively operative to browse the Internet. Browser 110 is directed to the domain of data center 50 and downloads a client 111. Client 111 appears as a web page on monitor 150, and contains various scripts and/or codes, which will be described further below. Scripts or codes of Client 111 are in one embodiment written in one of Flash, Javascript+DHTML known as AJAX, Silverlight and a Java applet.

Data center 50 is provided with at least one domain name, and preferably with multiple subdomains of the same domain name, and is operative to provide Client 111 with access to all Internet resources. A single computer 120 is illustrated, however this is not meant to be limiting in any way. In a preferred embodiment, a plurality of computers 120, terminals, set top boxes and/or cellular phones are provided each operative to download and run at least some features of Client 111.

The functions of Proxy server 3102 include one or more of:

Allow Client 111 to access any resources on the Internet even if browser 110 restricts Client 111 from accessing network resources from domains other than the domain from which Client 111 was downloaded.

Modify returned webpages and in particular modify hyperlinks and script network calls to point at the proxy server and preferably use multiple subdomains to allow the browser to have many parallel communications with the proxy server

Ensure that hyperlinks in Web Pages which are rendered in an iframe 402 within browser 110 target the inside of iframe 402 and do not target the entire browser. Otherwise clicking on a hyperlink within iframe 402 might cause the browser to unload Client 111 and replace Client 111 with the Web page which the hyperlink points to.

Perform single sign-in operations automatically free from the security restrictions that browser 110 may impose on Client 111. For example, Proxy server 3102 may automatically trigger a sign-in to a Third-party service when the user via Client 111 asks to access a URL or resource on that Third-party service that requires authentication, provided the user has chosen to store their authentication credentials for that Service in a Virtual Hosted Operating System on Proxy server 3102.

User Cookies from Third-party service providers may be stored in data center 50 so that no matter which computer 120 the user is utilizing to run Client 111, the same Cookies will be forwarded to the Third-party service providers they interact with.

Add affiliate codes to proxies URLs so that the Virtual Hosted Operating System provider may receive revenue from Third-party service providers who Virtual Hosted Operating System users browse via Client 111.

Perform extra processing such as translating RSS feeds which use language-specific Windows character sets into more standard UTF-8 Unicode encoding which is easier for Client 111 to process.

Track user's Internet browsing activities if user allows it.

### Implementation Details

### Proxy Server

Implementation details for a preferred embodiment of Proxy server 3102 may be understood by reference to FIG. 1. A user directs Client 111 running as an interactive Web page in browser 110 to display a Third-party web site www.example.com. The user may make this request directly by typing a URL in edit-text or indirectly by selecting an operation on a menu, selecting an item from a directory or any other means which directs Client 111 to enable the user to see a web site or run a web based service.

In an alternative embodiment one of the features of Client 111 is a browser-within-a-web-page 800, exhibiting a user interface 801 as illustrated in FIG. 5. User interface 801 exhibits at a minimum an edit-text box 802 for typing in a URL, and an iframe 402, or equivalent, for rendering the resultant Web page. The user may ask browser-within-a-web-page 800 to open a URL by typing a URL in edit text box 802, by choosing a URL from bookmarks or history or by other means. Optionally the browser may also have favorites or bookmarks stored in the Virtual File System, history and/or search.

Client 111, and more particularly the browser-within-a-web-page functionality within Client 111, initiates an HTTP request 3111 to Proxy server 3102. As described above Proxy server 3102 is a part of data center 50, which may incorporate an associated server farm. Proxy server 3102 exhibits the same domain as the domain from which Client 111 was downloaded from, or a subdomain thereof. For ease of understanding, the domain from which Client 111 was downloaded from is hereinafter termed “virtualoperatingsystem.com”. The HTTP GET or POST of HTTP request 3111 preferably codes the target URL:

http/www.target.com
as: http://proxy.virtualoperatingsystem.com/http/www.target.com
or as
http://proxy.virtualoperatingsystem.com?url=http://www.target.com.

In one embodiment if the target URL uses the HTTPS protocol then HTTP request 3111 will also use HTTPS.

Proxy server 3102 may be based on a web proxy or anonymous Web proxy preferably with the extra features described herein added. Preferably, Proxy server 3102 has the ability to relay an HTTP request, such as: http://proxy.virtualoperatingsystem.com/http/www.target.com to http://www.target.com and relay the response back Client 111.

Proxy server 3102 preferably comprises a single sign-on (SSO) functionality 3103 operative to automatically perform login or other authentication to a third party web site if requested by the user in HTTP request 3111. Specifically SSO functionality 3103 will check if the following conditions are met:
The target resource requires authentication. For example most Google Spreadsheets cannot be accessed without prior login. In one embodiment this is based on a list of domains which require login. In another embodiment the target is recognized as requiring authentication automatically if the initial response contains a string such as “not authorized” or a form with username and password; and
The user has previously registered in an identity repository 3200, part of data center 50, subscription identifying information such as a username and password for the service associated with the requested domain. Alternatively the user might be prompted for such credentials at the first sign on to a non-previously visited Web site requiring log in. For example, SSO functionality 3103 may send an HTTP response 3114 to Client 111 to display “do you want to store the username and password and log you in automatically to this service” responsive to a non-previously visited Web site requiring login.

In the event that the target resource required identification and the user has previously registered subscription identifying information in the identity repository, SSO functionality 3103 will send a GET or POST or other protocol to effect a sign-in prior to relaying the HTTP request 3111. SSO functionality 3103 receives back a Cookie or authentication token from the Web site target of HTTP request 3111, which is then attached to HTTP request 3111. HTTP request 3111 with the attached cookie is then forwarded to third party service 1010 as HTTP request 3112. Alternatively HTTP request 3111 might be authenticated by adding a digest of the username and password or using a sessionID, as described further below. Additionally, in one embodiment SSO functionality 3103 further stores the received cookie in a Cookie store 3124, which is preferably a part of data center 50.

Preferably Proxy server 3102 further comprises a Cache functionality 3104 operative to record HTTP request 3111, preferably associated with the identity of the user, time and optionally the IP address of the initiation Browser 110, in a history database 3126 of data center 50. History database 3126 which may be used to track browsing habits, analyze user behavior and/or gather statistics.

Preferably Cache functionality 3104 will also check if there is a reasonably fresh cached version of the requested Web resource stored in a provided Cache 3123 as part of data center 50, and if so this response will be sent as HTTP response 3114 to browser 110. Those skilled in the art will appreciate that there are well known techniques, as implemented by browsers, for deciding when it is appropriate to cache a web page and for how long by studying headers of the HTTP traffic. In another embodiment Cache functionality 3104 incorporates therein Cache 3123.

Proxy server 3102 further preferably provides a URL functionality 3110, having associated therewith a list of rules stored in a URL storage 3125, part of data center 50, which are used by URL functionality 3110 to make changes to the target URL such as adding affiliate codes so that the service providing Client 111 can receive revenue from the target Third-party Service 101 provider as described below. Preferably the rules are stored in a file where each rule is a condition, which may be one of the variations of regular expression language known in the art which is matched against the target URL, and an action which may be to add an HTTP name/value parameter or to execute some specific script for more complex processing of the URL.

Preferably a Cookie functionality 3105 is further provided as party of Proxy server 3102 and is operative to check if the User has any non-expired Cookies sent from the requested domain stored in Cookie store 3124 and if so those Cookies will be attached to the forwarded HTTP request 3112 in the manner specified by the HTTP protocol. The cookie functionality is further explained below.

HTTP request 3112 is sent to the target URL, and an HTTP response 3113 is received typically containing a Web page in HTML and often with attached cookies.

Preferably a Response Cookie functionality 3107 is further provided as part of Proxy server 3102, operative to copy cookies from HTTP response 3113 and store them in Cookie store 3124. Cookies store 3124 may be implemented as a file system with a folder for each user, or similarly stored on Amazon Web Services Simple Storage Service S3 using a bucket or object metadata for each user, or as a database such as a relational database or the Amazon Web Services SimpleDB Service without exceeding the scope of the invention. Further details of the Response Cookie functionality are provided below.

Preferably a parser functionality 3108 is further provided as part of Proxy server 3102 operative to look for URLs or other network addresses coded explicitly or implicitly in one of HTML, Javascript or other Web content in HTML response 3113 and will change the URLs or other network addresses to be via the proxy. For example, a hyperlink http://www.example.com/secondpage

within the web site HTML code in HTML response 3113 to:
http://proxy.virtualoperatingsystem.com/http/www.example.com/secondpage. The above process is sometimes known as proxifying the Web content.

Advantageously, proxy server 3102 may be respondent to multiple subdomains and may perform the above modifications to HTML response 3113 using multiple subdomains in order to overcome any restriction the browser has on the number of simultaneous connections to a single domain. For example if the proxy server 3102 sees a plurality of network call and in response a plurality of HTML responses 3113, proxy server 3102 is in one embodiment operative to change the proxy redirect in round-robin fashion to any one of:

http://proxy1.virtualoperatingsystem.com/http/www.example.com/secondpage
http://proxy2.virtualoperatingsystem.com/http/www.example.com/secondpage
http://proxy3.virtualoperatingsystem.com/http/www.example.com/secondpage
so that when the browser follows all links it will be able to access more than two simultaneously.

In certain embodiment some resource URLs such as images or video, which are unlikely to contain URLs or network addresses within them, might not be proxified so that browser 110 can retrieve them directly from Third-party service 1010 and reduce any load on Proxy server 3102. Preferably some rules are stored in parser functionality 3108 to determine which resource and which sites utilize are not proxified. For example if there are no cookies being sent by Third party service 1010 it is likely safe to leave media resources unproxified.

Preferably parser functionality 3108 will also change the target of any explicit or implicit (in script) hyperlink in the Web content which targets_top (meaning the entire browser page), since if the user clicks on the hyperlink the browser is likely to render the next Web page to the whole browser screen and not within the iframe 402 thereby causing Client 111 to be unloaded by browser 110. Therefore the target_top is preferably replaced with a target name equal to the name given by Client 111 to iframe 402.

There is preferably a Response cache functionality 3109 further provided as part of Proxy server 3102 operative to determine if the requested Web resource is often requested by querying history database 3126, and does not change frequently, typically indicated by use of GET rather than POST, or based on other criteria, and if so keeps a copy of the content of the response in cache 3123. HTTP headers in the response may also indicate if the page is appropriate to cache in cache 3123.

Finally, HTTP response 3113, optionally with cookies removed and with the other modifications described above, is forwarded as HTTP response 3114 as a response to HTTP request 3111.

By way of a more detailed example for how storing cookies can help the User, suppose a User logs in to the service providing Client 111 once from a Browser in a first computer 120 and later from a second computer 120.

The user asks Client 111 at first computer 120 to open www.someservice.com and Client 111 opens an iframe 402 and directs it to proxy.virtualhostedoperatingsyste.com/http/www.aservice.com. The user then logs in with username ‘x’ and password ‘y’ to aservice.com by filling a form which causes an HTTP POST to be sent via the proxy: proxy.virtualhostedoperatingsyste.com/http/login.aservice.com%username=x&password=y aservice.com sends a Cookie in response in order to remember the user's identity. The cookie is kept on Cookie store 3124 while the response is sent Client 111 running on first computer 120. The user logs off of first computer 120.

Later, the same user accesses second computer 120 and asks Client 111 to open someresource.aservice.com asking for a resource which requires login to aservice.com. The request is sent via Proxy server 3102 where Cookie functionality 3105 adds the cookie that was stored earlier in cookies store 3124. In this manner a type of single sign-in is effected, in addition to the option of an explicit single sign in by SSO functionality 3103, where a sign-in to a third-party service from one instance of Client 111 leads to a seamless sign-in from all instances of Client 111.

### An Alternative Embodiment of the Cookie Functionality Aspect of the Invention

Response Cookie functionality 3107 presented above presents some specific problems. In one embodiment, Response Cookie functionality 3107 will strip cookies off the response, store them in cookies store 3124, and not forward cookies to Client 111. The problem is that sometimes code within the returned web page, typically Javascript code, will read those cookies, and will not function correctly if the cookies are not present.

In another embodiment, response Cookie functionality 3107 is operative to store the cookies in cookies store 3124 and also forward cookies to the Client. The problem is that when Proxy server 3102 is in use all the cookies will be coming from the same domain. Browser 110 will normally prevent Javascript from one site from reading cookies from a second site. Unfortunately, in this case, the cookies will both be from the same domain and browser 110 will not prevent the cookies from reading each other causing a privacy and security concerns. Furthermore browser 110 will often only allow storage of up to say 30 cookies per domain, but in the present situation cookies from multiple domains are proxied through one domain, and thus this restriction may be unacceptable.

According to an embodiment of the invention, the above difficulties are resolved, as illustrated in FIG. 3, by sending the content of the cookies to Client 111, however not as cookies. Instead contents of the cookies are inserted into the content of HTTP response 3114 preferably as Javascript objects or other data accessible by Javascript such as ProxyCookie objects described further below. In one further embodiment multiple cookies are aggregated into one cookie object and optionally encrypted. This may be described as cookie encapsulation.

Furthermore, the Javascript in the response page is examined for any code which attempts to read cookies and the code is modified to make it read the cookies instead from the ProxyCookie objects, respectively. Specifically code references to Javascript interface document.cookie are intercepted and modified to access the encapsulated cookies instead of the cookies in the normal browser cookie cache.

In this embodiment the response cookie processing by response cookie functionality 3107 is implemented in one of two methods. In a first method, response cookie functionality 3107 collects all valid cookies from HTTP response 3113 and dynamically creates JavaScript code that creates an array of ProxyCookie objects containing the individual cookies. This ProxyCookie objects are appended to a predefined code block that defines methods that imitate the standard document.cookie interface, namely a read operation and a write operation. These methods will be called when the scripts in the third-party page attempt to call the document.cookie interface and will provide the replacement behavior for document.cookie. A script tag is placed within in the response page HTML head section, making sure it executes the ProxyCookie objects first.

In a second method, resources are injected into the head section of the client HTML page. This resource link commands Client 111, or iframe 402 to issue a method request from Proxy server 3102, which, using information in the header, gathers valid cookies from a copy of HTML response 3113, optionally stored in history database 3126, encapsulates the cookies as described in the first method, and sends them back as an HTML response 3114.

In, this embodiment no cookies are stored in the Browser's cookie storage, and the web page code displayed in the browser-within-a-web-page iframe 402 has no way to access the real document.cookies.

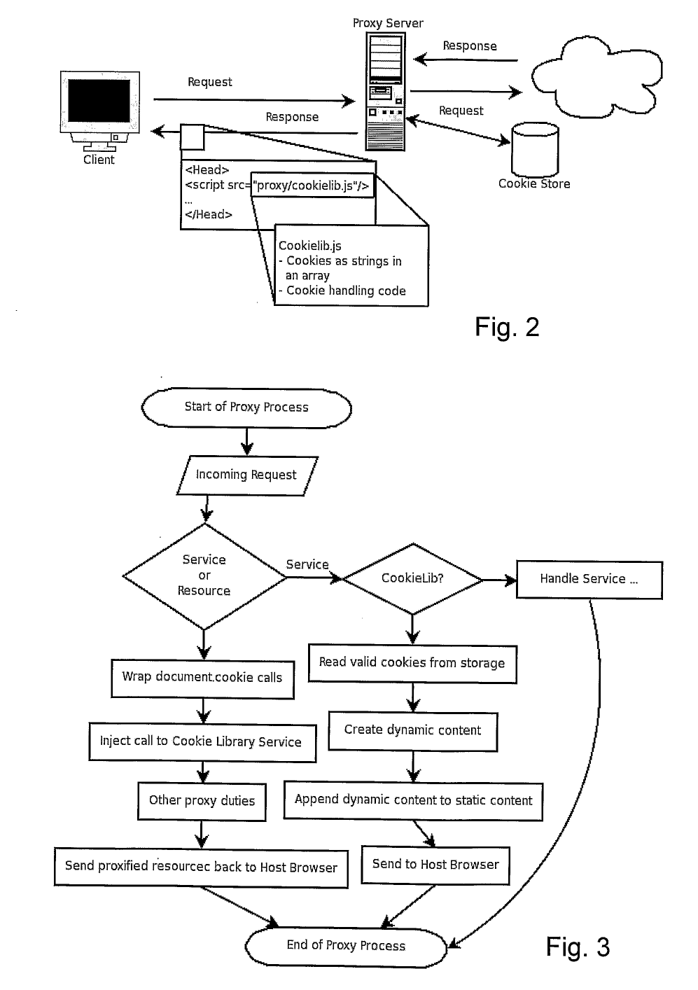

The above is further illustrated in FIG. 2, in which the cookies are illustrated as being forwarded as strings in an array.

Those skilled in the art will be able to choose their own code to implement this concept but some suggested implementation details for this embodiment of response cookie functionality 3107 follow.

### ProxyCookie Object:

### ProxyCookie Object Attributes:

Name: Cookie Name. Cookies with the same name and domain/path are the same.
Value: Cookie Value.
Expiry: Expiry date for the cookie.
Secure: If set, the cookie will only be sent over secure connections.
Domain: The cookie is valid only on this domain and any of its sub domains.
Path: The cookie are valid for all pages inside this path.

### ProxyCookie Object Methods:

toString( ): Used for automatic conversion between ProxyCookie and String. Returns Name/value pair in standard cookie format.

### Interface Methods

getCookies( ): Returns a string containing all cookies as name/value pairs. Corresponds to document.cookie calls as a value expression.
writeCookie( ) Writes a single cookie to our storage. Corresponds to document.cookie calls as an assignment expression.

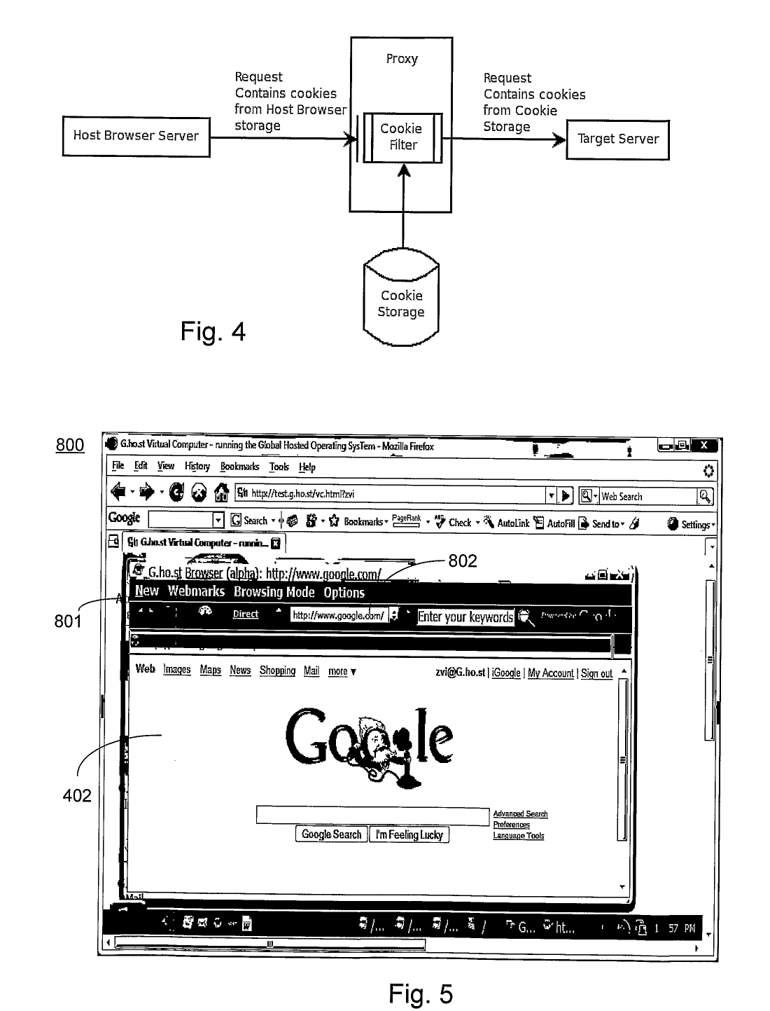

In one embodiment cookie store 3124 is implemented using a file system, and in another embodiment cookies store 3124 is implemented using an Amazon Simple Storage Service bucket. Taking Simple Storage Service bucket as an example, cookies are stored in objects, identified by a user name and a base domain name. Cookies from sub-domains are preferably all stored in the object identified by the base domain. For example, cookies from docs.google.com and cookies from images.google.com will be stored in a single object identified by user name and the base domain ‘google.com’. This is preferred for performance reasons, since a single query to the database per domain for retrieving all relevant cookies including those in subdomains may be performed. After cookies are retrieved from cookie store 3124, those in irrelevant subdomains may be filtered out by response cookie functionality 3107. The above filtering action is illustrated in FIG. 4.

### Identity Repository

As described above, in one embodiment identity repository 3200 is provided, operative to store identity information for a user associated with each third-party service 101. The stored identity information is preferably utilized for logging in to third-party web site automatically. In one embodiment identity repository 3200 is implemented using a three-tier architecture of database, business logic (e.g. using Java servlets) and presentation layer. Preferably, a secure communications standard such as HTTPS is used for transmitting sensitive data such as passwords.

Typical classes (or database tables) used in identity repository 3200 might be:
ServiceProvider—a legal entity who might offer a service that requires login (attributes might be: legal name, home page);
ThirdPartyAccountType—associated with a ServiceProvider—a type of account that user's sign up to (attributes might be: URL of sign-up page, URL of terms of service, description);
SubscriptionWebPages—associated with a ThirdPartyAccountType—lists Web pages which require login—e.g. by providing a URL with regular expressions—that require login;
LoginScheme—a scheme associated with a ThirdPartyAccountType for performing login—one typical subclass would be PostLoginScheme where login to a web site is by doing an HTTP POST to a give URL with given tags for username and password;
AuthenticationScheme—a scheme to authenticate calls made to SubscriptionWebPages without prior login e.g. using the OAuth standard (www.oauth.net); and
ThirdPartyIdentity—associated with a user and a ThirdPartyAccountType and capturing the account login credentials (usually username and password) which a user logs in to that ThirdPartyAccountType

Identity repository 3200 preferably contains sufficient information about third party services 101 which require login, which URLs require login, how to perform login or authentication and some user's specific authentication credentials, in order to perform automatic single sign-on.

### Single Sign on

In certain embodiment SSO functionality 3103 automatically logs the user into certain web sites. In order to utilize this feature identity repository 3200 described above should be present and should have data on service providers, services and specific web sites URL which require sign-on and on the user's identity information (typically username and password) for some such services and on the specific authentication scheme used. In a preferred embodiment multiple protocols for single sign-on are supported.

A first embodiment of a single sign-on protocol involves simulating the submission of a login form as the user would normally do themselves from browser 110. This usually involves sending a POST to a URL with name-value parameters for username and password. In order to enable execution of this protocol, identity repository 3200 and specifically the LoginScheme class or table should capture data such as URL (say https://thirdParty.com/login.jsp) and tags (say usernm and passwd) and timeout time (say 30 minutes). Optionally the LoginScheme should capture data about what a successful response looks like (e.g. contains the string “welcome”) and what a non-successful response looks like (e.g. contains the string “wrong password”).

When Client 111, and in particular the browser-within-a-web-page of Client 111, is pointed at a URL, such as http://thirdParty.com/privateService.html, SSO functionality 3103 checks if that URL matches a known SubscritpionWebPages, i.e. requires login, and if so it will check whether the current user of Client 111 has on record a ThirdPartyIdentity (e.g. username and password) for the associated ThirdPartyAccountType. If so, SSO functionality 3103 will initiate an HTTP POST and transmit it as an HTTP request 3112 to third party service 1010 to perform login. HTTP response 3113 from third party service 101 will come with a cookie which will be captured by response cookie functionality 3107 as described above, and stored in cookie store 3124, preferably associated with a validity time of the cookie. In one embodiment, the timeout time is retrieved from identity repository 3200, added to the retrieval time, and stored as an end validity. In another embodiment, validity of the cookie is determined by SSO functionality 3103 by adding the retrieval time of the cookie in cookie store 3124 to the timeout time of the web site from identity repository 3200, and comparing the result to the present time. The user's original request to retrieve http://thirdParty.com/privateService.html will then be forwarded to third party service 1010 with the cookie attached by cookie functionality 3105 as described above.

Subsequent requests for a period of time will typically not require another single sign-on since the cookie in cookie store 3124 will still be valid. As indicated above, in one embodiment SSO functionality 3103 checks the timeout of the cookie as stored in cookie store 3124 to decide when the login step must be repeated.

In another embodiment the request to http://thirdParty.com/privateService.html is forwarded without a preceding login request, but instead authentication information is added to the request. For example the OAuth standard (www.oauth.net) allows a digest of the URL plus the user's username and password to all be added to the request as an HTTP header thereby authenticating of the user.

In yet another embodiment, authentication involves submitting the user's identity information, e.g. username and password, to an application programming interface (API) of third party service 101 as an HTTP request 3113. Third party service 101 receives a sessionID from third party service 101 as part of HTTP response 3113. SessionID acts a temporary password which is attached to subsequent HTTP requests. SSO functionality 3103, further exhibits a sessionID cache 3150, which is used by SSO functionality 3103 to store the retrieved sessionID for as long as it is valid. SSO functionality 3103 continues to attach the stored sessionID to all URLs associated with the particular third party service 101 to which it is associated.

These specific protocols are described without limitation and other protocols may also be relevant to allow Proxy server 3102 to perform singe sign-on on behalf of the user. Further similar single-sign on logic may instead be embedded in the browser-within-a-web-page code or in the containing Client.

Browser within a Web Site

Referring to FIG. 5, in one embodiment browser-within-a-web-page 800 running in Client 111 comprises at least an iframe 402, or similar construct, an edit text box 802 for inserting a URL and some simple logic to take any URL inserted by the user in text box 802, add it as a parameter on the URL of Proxy server 3102, and set it as the ISRC of iframe 402 in order to cause browser 110 to send the request to Proxy server 3102 and render the response in iframe 402. Once this core functionality is in place, those skilled in the art will understand how to add familiar browser features such as:
An indicator that a page is loading, which shows until an onload event is caught from iframe 402;
The ability to save and recall the URLs as bookmarks;
An address bar to show the current URL in iframe 402, which is responsive to a new page loading if the user clicks on a hyperlink;
Default home page;
The ability to open several tabs each with its own iframe 402; and
Capturing a browsing history.

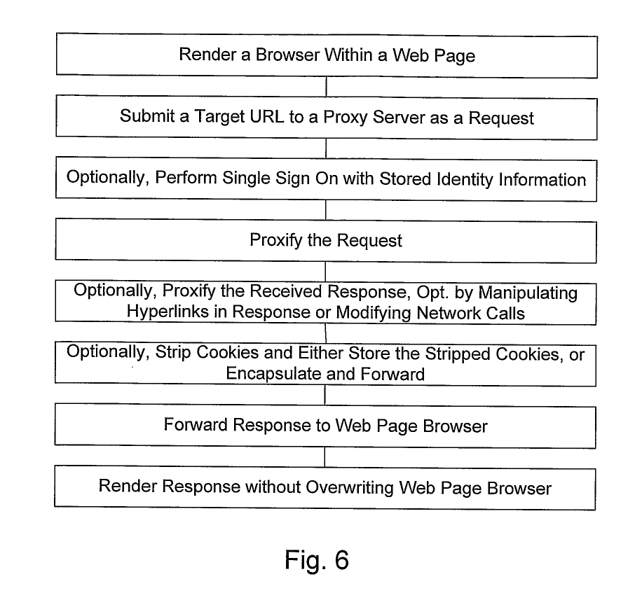

Thus, the present embodiments enable a computer implemented method of implementing a web proxy server and its application to implementing a browser-within-a-web-page. A summary of the method according to certain embodiments of the invention is illustrated in FIG. 6.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

Unless otherwise defined, all technical and scientific terms used herein have the same meanings as are commonly understood by one of ordinary skill in the art to which this invention belongs. Although methods similar or equivalent to those described herein can be used in the practice or testing of the present invention, suitable methods are described herein.

All publications, patent applications, patents, and other references mentioned herein are incorporated by reference in their entirety. In case of conflict, the patent specification, including definitions, will prevail. In addition, the materials, methods, and examples are illustrative only and not intended to be limiting.

The terms “include”, “comprise” and “have” and their conjugates as used herein mean “including but not necessarily limited to”.

It will be appreciated by persons skilled in the art that the present invention is not limited to what has been particularly shown and described hereinabove. Rather the scope of the present invention is defined by the appended claims and includes both combinations and sub-combinations of the various features described hereinabove as well as variations and modifications thereof, which would occur to persons skilled in the art upon reading the foregoing description.

We claim:

1. A computer implemented method of browsing, comprising:
rendering a browser within a web page;
indicating a target URL to said web page browser;
submitting said input target URL to a proxy server as a request;
forwarding said proxified request to said target URL;
receiving a response to said proxified request; and
forwarding said received response to said rendered web page browser,
wherein said web page browser renders the forwarded response without being overwritten.

2. A computer implemented method according to claim 1, further comprising proxifying said receive response, wherein said response forwarded to said rendered web page browser is said proxified received response.

3. A computer implemented method according to claim 2, wherein said proxifying said received response comprises manipulating hyperlinks in the received response.

4. A computer implemented method according to claim 3, where said manipulated hyperlinks point alternately at more than one subdomain.

5. A computer implemented method according to claim 2, wherein said proxifying said received response comprises replacing hyperlinks operative to overwrite said web page browser with hyperlinks to said web page browser.

6. A computer implemented method according to claim 2, wherein said proxifying said received response comprises modifying network calls in executable code in said received response.

7. A computer implemented method according to any of the preceding claims, further comprising:
stripping any cookie attached to said received response;
storing said stripped cookie; and
attaching said stored cookie to a subsequent request to a URL associated with said stored cookie.

8. A computer implemented method according to claim 1, further comprising:
encapsulating any cookie attached to said received response; and
forwarding said encapsulated cookie to said web page browser.

9. A computer implemented method according to claim 1, further comprising:
stripping any cookie attached to said received response;
appending said cookie to said received response as an object,
wherein said forwarded received response comprises said appended cookie object.

10. A computer implemented method according to claim 9, wherein said object is a Javascript object.

11. A computer implemented method according to claim 1, further comprising prior to said forwarding said proxified request:
performing a single sign on to said target URL utilizing stored identity information.

12. A computer implemented method according to claim 11, wherein said performing said single sign-on comprises sending an HTTP POST with said stored identity information.

13. A computer implemented method according to claim 1, further comprising prior to said forwarding said proxified request:
modifying the request with a digest responsive to stored identity information, thereby performing single sign on.

14. A computer implemented method according to claim 1, further comprising adding affiliate codes to the request.

15. A computer implemented method according to claim 1, wherein said web page browser shows a loading indicator while the received response is rendering.

16. A machine-readable medium containing instructions for controlling a device to perform a machine implemented method of browsing, the method comprising:
rendering a browser within a web page;
inputting a target URL in an input field of said web page browser;
submitting said input target URL to a proxy server as a request;
proxifying said request;
forwarding said proxified request to said target URL;
receiving a response to said proxified request; and
forwarding said received response to said rendered web page browser,
wherein said web page browser renders the forwarded response without being overwritten.

17. A machine-readable medium according to claim 16, wherein said method further comprises proxifying said receive response, wherein said response forwarded to said rendered web page browser is said proxified received response.

18. A machine-readable medium according to claim 17, wherein said proxifying said received response comprises manipulating hyperlinks in the received response.

19. A machine-readable medium according to claim 17, wherein said proxifying said received response comprises replacing hyperlinks operative to overwrite said web page browser with hyperlinks to said web page browser.

20. A machine-readable medium according to claim 19, where said manipulated hyperlinks point alternately at more than one subdomain.

21. A machine-readable medium according to claim 17, wherein said proxifying said received response comprises modifying network calls in executable code in said received response.

22. A machine-readable medium according to claim 16, wherein said method further comprises:
stripping any cookie attached to said received response;
storing said stripped cookie; and
attaching said stored cookie to a subsequent request to a URL associated with said stored cookie.

23. A machine-readable medium according to claim 16, wherein said method further comprises:
encapsulating any cookie attached to said received response; and
forwarding said encapsulated cookie to said web page browser.

24. A machine-readable medium according to claim 16, wherein said method further comprises:
stripping any cookie attached to said received response; and
appending said cookie to said received response as an object,
wherein said forwarded received response comprises said appended cookie object.

25. A machine-readable medium according to claim 24, wherein said object is a Javascript object.

26. A machine-readable medium according to claim 16, wherein said method further comprises prior to said forwarding said proxified request:
performing a single sign on to said target URL utilizing stored identity information.

27. A machine-readable medium according to claim 26, wherein said performing said single sign-on comprises sending an HTTP POST with said stored identity information.

28. A machine-readable medium according to claim 16, wherein said method further comprises prior to said forwarding said proxified request:
modifying the request with a digest responsive to stored identity information, thereby performing single sign on.

29. A machine-readable medium according to claim 16, wherein said method further comprises adding affiliate codes to the request.

30. A machine-readable medium according to claim 16, wherein said web page browser shows a loading indicator while the received response is rendering.

31. A proxy server operative to enable virtual hosting, said proxy server comprising:
a downloadable client exhibiting a web page within a browser; and
a proxifying functionality operative to:
proxify requests received from said web page browser;
forward said proxified request to said target URL;
receive a response to said proxified request; and
forward said received response to said web page browser,
wherein said web page browser renders the forwarded response without being overwritten.

32. A proxy server according to claim 31, wherein said proxifying functionality is further operative to:
proxify said receive response, wherein said response forwarded to said rendered web page browser is said proxified received response.

33. A proxy server according to claim 31, wherein said proxifying said received response comprises manipulating hyperlinks in the received response.

34. A proxy server according to claim 33, wherein said manipulated hyperlinks point alternately at more than one subdomain of the domain of the proxy server.

35. A proxy server according to claim 31, wherein said proxifying said received response comprises replacing hyperlinks operative to overwrite said web page browser with hyperlinks to said web page browser.

36. A proxy server according to claim 31, wherein said proxifying said received response comprises modifying network calls in executable code in said received response.

37. A proxy server according to claim 31, further comprising a cookie functionality and a cookie store, said cookie functionality operative to:
strip any cookie attached to said received response;
store said stripped cookie in said cookie store; and
attach said stored cookie from said cookie store to a subsequent request to a URL associated with said stored cookie.

38. A proxy server according to claim 37, wherein said cookie functionality is further operative to:
encapsulate any cookie attached to said received response; and
forward said encapsulated cookie to said web page browser.

39. A proxy server according to claim 31, further comprising a cookie functionality operative to:
strip any cookie attached to said received response; and
append said cookie to said received response as an object,
wherein said forwarded received response comprises said appended cookie object.

40. A proxy server according to claim 39, wherein said object is a Javascript object.

41. A proxy server according to claim 31, further comprising a single sign on functionality operative, prior to said forwarding said proxified request, to:
perform a single sign on to said target URL utilizing stored identity information.

42. A proxy server according to claim 41, wherein said performing said single sign-on comprises sending an HTTP POST with said stored identity information.

43. A proxy server according to claim 31, further comprising a single sign on functionality operative, prior to said forwarding said proxified request, to:
modify the request with a digest responsive to stored identity information, thereby performing single sign on.

44. A proxy server according to claim 31, further comprising a URL functionality operative to adding affiliate codes to the request.
